(19) United States
(12) Patent Application Publication
(10) Pub. No.: US 2015/0167888 A1
(43) Pub. Date: Jun. 18, 2015

(54) APPARATUS FOR THERMAL MANAGEMENT OF HYDROCARBON FLUID TRANSPORT SYSTEMS

(71) Applicant: FRAMO ENGINEERING AS, Bergen (NO)

(72) Inventor: Stig Kanstad, Bergen (NO)

(21) Appl. No.: 14/413,169

(22) PCT Filed: Jul. 8, 2013
(86) PCT No.: PCT/EP2013/064352

§ 371 Date: Jan. 6, 2015

(30) Foreign Application Priority Data
Jul. 6, 2012 (GB) 1212100.0

(51) Int. Cl. F16L 59/16; E21B 36/00; F16K 49/00

(52) U.S. Cl. CPC F16L 59/16; F16K 49/00; E21B 36/003

(57) ABSTRACT

Apparatus for thermal management of a hydrocarbon fluid transport system, the apparatus comprising means adapted to maintain the temperature of hydro-carbon fluid in the transport system at a temperature above the temperature at which hydrocarbon hydrates will form. Heat loss between a valve body (1) and its actuator (11) can be reduced by insulating the stem (13) connecting them. A trap (65) for warm water can be used around a pipeline to reduce heat loss due to convection. A pump or compressor can be thermally connected to bypass line so as to be effectively thermally one unit.

### FIELD OF THE INVENTION

The present invention relates to an apparatus for thermal management of fluid in fluid transfer systems, and particularly to fluid transfer in hydrocarbon exploration and production systems. It is particularly applicable to subsea and deep sea systems.

### BACKGROUND

In subsea oil and gas systems extreme conditions of temperature and pressure can be experienced by the process fluid being extracted or processed, particularly when exploration or production takes place in very deep water. It is more difficult to monitor and service equipment in deep sea environments. The fluids being transported will often be at relatively high temperature and pressure due to the process of extraction, but the ambient surroundings, i.e. the sea water, will generally be at a very low temperature and will tend to cool the fluid and cold spots form. Cooling tends to cause hydrates, wax, salts, and ice to form, any of which can reduce flow speed or even block the flow line. Ice is usually formed due to JT cooling or caused by temperature drop due to hydrate resisting melting.

Such problems are made worse when part of a system is closed off or isolated from the rest of the system, so that fluid flow is reduced or even stopped. Such a closed off part of a system is often referred to as a “dead leg”. This may for example be a length of pipe or a blind flange connecting the primary flow line to a sub-station, such as a pumping station, or a module for testing or for chemical injection. Since fluid in a dead leg flows more slowly, or is stationary, it tends to cool more quickly by conduction of heat through the wall of the dead leg (e.g. a pipe wall), which might be surrounded by the cooler deep sea water. In addition sand and other debris is more likely to precipitate from slow flowing or stationary fluid, and this can also affect fluid flow and block flow lines.

Such cold spots in flow lines and in dead legs also cause problems in the system because blocked lines may not be usable when they are needed. This situation may lead to loss of functionality, loss of production or a request for maintenance, which may result in unwanted cost or delay in production. Additionally, dead legs potentially cause a dangerous situation to people and the environment. When a dead leg contains a blockage, trapped pressurised gas can suddenly eject the blockage as it loosens. In such a situation the fluid line might be depressurized equally on both sides of the blockage, to minimise the likelihood of such a dangerous ejection, which causes expensive down-time.

Valves are particularly prone to cold spots when they are turned off. In addition, valves and actuators act as large heat sinks where they are connected to production pipe lines, because they have large surface areas exposed to cooling temperatures, compared to the cross sections of the pipes conveying hot production fluid. This causes cold spots to develop in pipelines near valves making production control more difficult because neither steady state nor cool down functionalities can be accurately met.

Known methods of reducing heat loss in fluid transport systems include establishing thermal contact between a part of a system in which hot fluid is flowing and a part in which fluid flow is reduced or halted, e.g. a dead leg. This is described for example in WO 2010/137989.

GB 2468920 describes removing hydrates in a subsea cooler module by depressurisation but this requires production flow to be stopped resulting in expensive down time.

### SUMMARY

Novel methods and apparatus will be described below which can be used to allow equipment to operate satisfactorily in much deeper water than currently possible.

This summary is provided to introduce a selection of concepts that are further described below in the detailed description. This summary is not intended to identify key or essential features of the claimed subject matter, nor is it intended to be used as an aid in limiting the scope of the claimed subject matter.

According to one aspect of the invention, there is provided apparatus for thermal management of a sub-sea hydrocarbon fluid transport system, the apparatus comprising means adapted to maintain the temperature of fluid in the transport system at a temperature above the temperature at which hydrates will form. The apparatus may comprise an inhibitor arranged to inhibit thermal conduction from the fluid to the ambient atmosphere. This may comprise insulation material, for example arranged along a stem connecting a valve, which is operable to change a rate of fluid flow through a pipe, to an actuator which is operable to control operation of the valve.

The insulating material may be located within a hollow part of the stem connecting the valve to the actuator.

According to an embodiment, the inhibitor comprises a support plate, connecting the valve to the actuator, and adapted to inhibit thermal conduction.

The inhibitor may comprise a plurality of plates arranged adjacent to each other and to the support plate. The use of a plurality of plates inhibits the flow of heat between the valve and the actuator because heat is conducted across a plurality of plates less effectively than across a single support plate.

The inhibitor may comprise means for thermally insulating a valve actuator from sea water surrounding the actuator.

According to an embodiment, the inhibitor comprises a housing surrounding the actuator. This may be filled with insulating material for example bubble wrap. It may have a complex internal shape designed to reduce the rate of heat transfer between the actuator and the surrounding physical environment such as sea water.

The housing may comprise an inner housing, an outer housing and an insulating material between the inner and the outer housing. This serves to further reduce the rate of heat transfer between the actuator and the physical environment surrounding the actuator.

According to another embodiment, the inhibitor comprises a plurality of valves thermally connected together. Two or more valves may be thermally connected over a predetermined area, such that the combined surface area of the thermally connected valves is less than the sum of the surface areas of the plurality of valves when they are not thermally connected together.

According to another embodiment the inhibitor comprises means for closely thermally coupling together a compressor or a pump and a bypass line of a valve system so that they can be considered as together forming a single thermal unit.

According to another embodiment the system comprises a water trap in thermal communication with process fluid, the water trap being arranged to reduce convection in the water in the trap.

The rate of heat loss of any material is dependent on the mass of the material, the nature of the material, i.e. its inherent thermal capacity and conductivity, and on the temperature difference between the temperature of the material and its ambient surroundings.

### BRIEF DESCRIPTION OF THE DRAWINGS

For a better understanding of the invention and to show how the same may be carried into effect, reference is made to the accompanying drawings in which:

FIG. 1 is a cross-sectional view of one embodiment;

FIG. 2 is a perspective view of the apparatus of FIG. 1;

FIG. 3 is a cross-sectional view of another embodiment;

FIG. 4 is a cross-sectional view of an alternative embodiment;

FIG. 5 is a cross-sectional view along line VI-VI of FIG. 4;

FIG. 6 is a cross-sectional view of another embodiment;

FIG. 7 is a partially transparent, isometric view of the embodiment of FIG. 6;

FIG. 8 is a schematic view of another embodiment;

FIG. 9 is a schematic view of another embodiment;

FIG. 10 is a schematic view of another embodiment;

FIG. 11 is a schematic view of another embodiment;

FIG. 12 is a schematic view of another embodiment; and

FIG. 13 illustrates another embodiment.

### DETAILED DESCRIPTION OF THE DRAWINGS

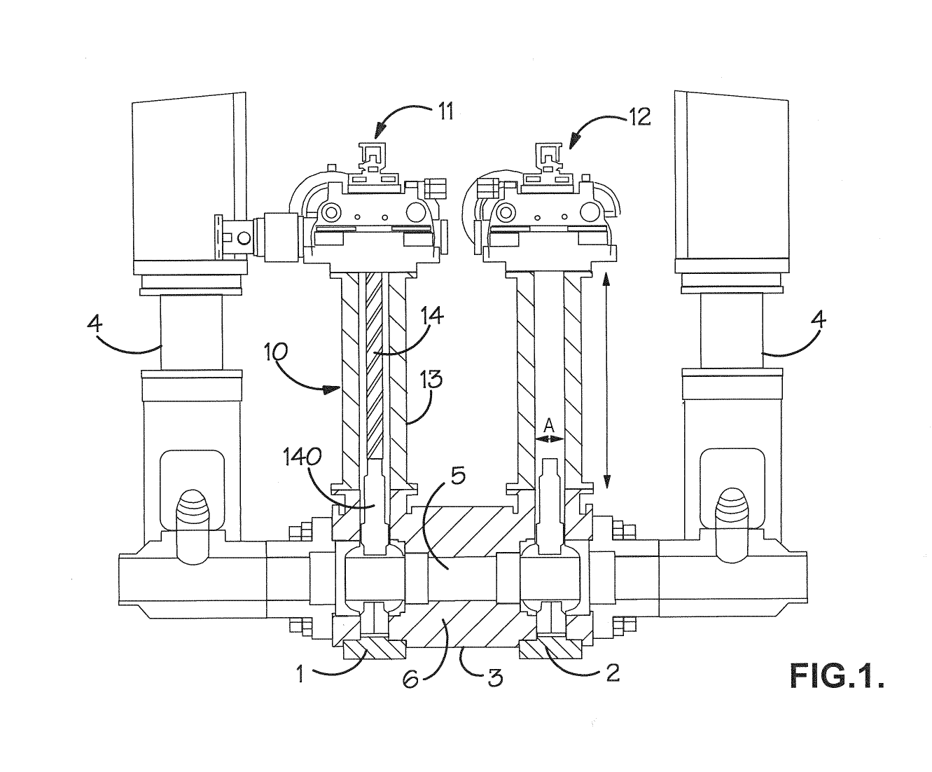

FIG. 1 shows one embodiment which might be applicable to large production valves such as large dual ball valves. Two valves 1 and 2 are combined block 3 in a single thermal which surrounds the production pipeline 4. This block 3 may comprise thermally conductive material 5 arranged to transfer heat from the process fluid to the valves 1 and 2 and insulating material 6 to resist heat transfer to the ambient environment.

Combining the valves in one block increases the internal volume to external surface area ration of the valve unit as a whole and thus inhibits the rate of heat loss from the unit, and thus also from the pipeline 4. This effectively increases heat storage and increases cool down time in the combined valves 1 and 2 and reduces the severity of cold spots and means that any dead legs upstream and downstream, which are formed when the valves are closed, are less likely to become blocked.

Any combination of valves may be made, for example any or a plurality of station isolation valves, bypass valves, production flow valves and others may be made whether the valves operate in the same line or not. Thus vertical and horizontal valves may be combined.

Currently in large subsea valves, the valve and the actuator are close coupled to inhibit heat loss, i.e. the actuator is normally placed directly on the valve body. This is in contrast to topside valves where the valve and actuator might be split using a yolk to provide visibility for leak inspection, easier maintenance access and to protect the actuator from the high temperatures of the production fluid in the pipeline.

Another embodiment comprises providing a spacer 10 between the valve body 1, 2 and the respective actuator 11, 12 in a subsea valve. The spacer may optionally be insulated. This avoids the difficult problem of effectively insulating actuators which tend to be large for large valves and tend to be highly prone to cold spots, so are difficult to insulate.

This is shown in cross section in FIG. 1 where a spacer 10 between valve 1 and valve actuator 11. The spacer 10 has a steel wall 13 and an insulation material 14 is shown in the hollow inside of the spacer 10. The insulation material may be foam or other material with a low thermal conductivity. The insulation serves to reduce heat convection resulting from internal circulation in a hollow stem and thus reduce axial heat transfer from the valve to the actuator. Using stainless steel INSTEAD of carbon steel in the spacer wall 13 also reduces heat loss. Carbon steel has a thermal conductivity of about 50-60 w/m/k but stainless steel only 16-17 w/m/k.

The spacer 10 connects with a stem 140 which connects with valve 1. The stem 140 may also be constructed of hollow stainless steel and have insulating material such as foam inside.

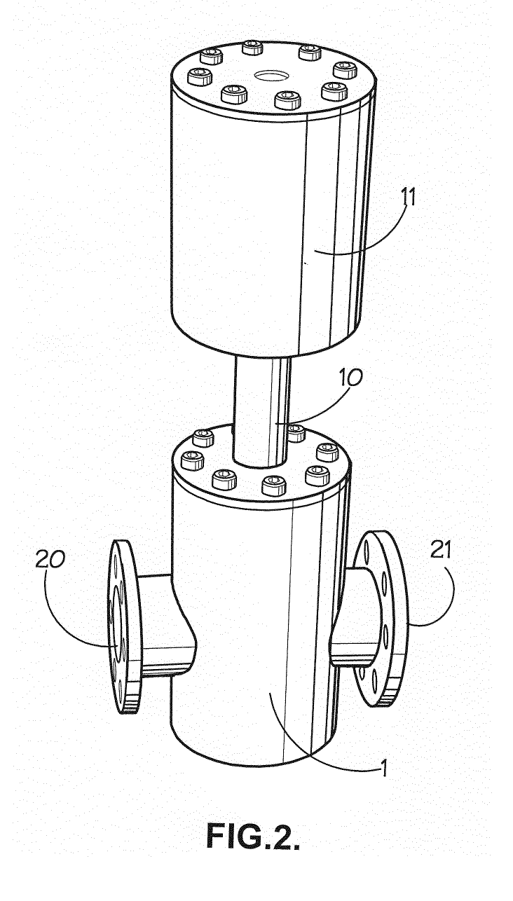

FIG. 2 shows a perspective view of such an actuator unit with the valve 1 being a large dual ball valve for a main bypass header in the production line and in which inlets 20, 21 for two station isolation valves are shown.

This configuration leads to the fact that the heat transferring cross section is inhibited to the cross section of the stem 10.

In another embodiment, thermal conduction might be inhibited on small valves which are used for example for chemical injection into subsea pipelines, e.g. injection of demulsifier, methanol or other chemicals which may be used to aid flow, inhibit hydrate formation or for other purposes such as taking samples of production fluid.

This type of valve might not be in continuous use and there is a danger in subsea use of them becoming frozen so not functioning when required. Further, they might be joined to process piping by a long pipe due for example to required distances between welds or required space for bolts etc. This distance might be more than 100 mm.

The embodiment proposes using an enlarged valve housing which is then welded or flanged to the process pipe. This may allow eliminating the joining pipe which can be a source of cold spots. It also shortens the distance from the hot process fluid in the process pipe and thus improves heat conduction. In addition it provides an increased thermal mass in the combined process pipe/valve body which acts as a conductor and also as a thermal battery.

The actuator can be split from the valve body by a spacer, as described above for large valves.

Further, the injection tapping between the valve gate and the process piping might be of conical form or otherwise having a generally tapering profile so that if an ice plug forms it will be more easily pushed out by the injection fluid when the valve is opened.

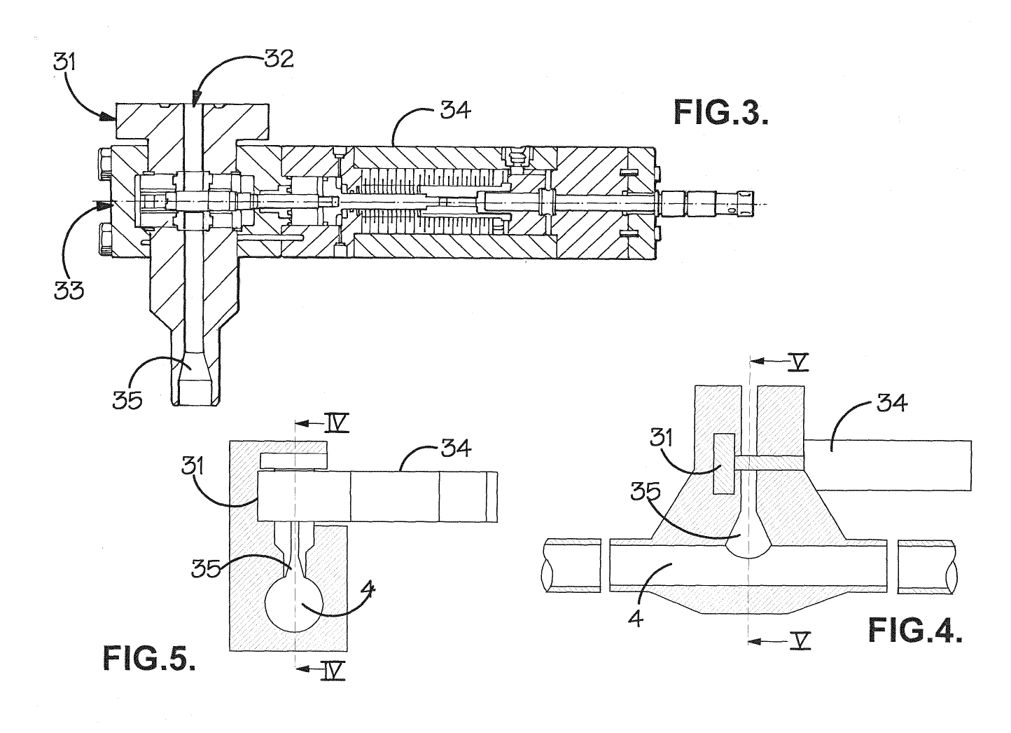

FIG. 3 shows a cross sectional view of such a close coupled small injection valve 31. Chemicals are injected via valve injection tube 32 and flow is controlled by the valve gate mechanism 33 operated by the actuator 34. The injection tube 32 advantageously has a conical shape 35 at the end which is welded to the process pipe as is shown more clearly in the cross sectional views of FIGS. 4 and 5 which show the valve body and process pipe 4 integrated together.

According to another embodiment it is proposed to create a thermal trap around sections such as dead legs or junctions which are liable to cold spots. A thermal water trap aims to prevent cold and warm water mixing by trapping warm water adjacent areas of particular concern, to prevent it rising and being replaced by heavier cold water.

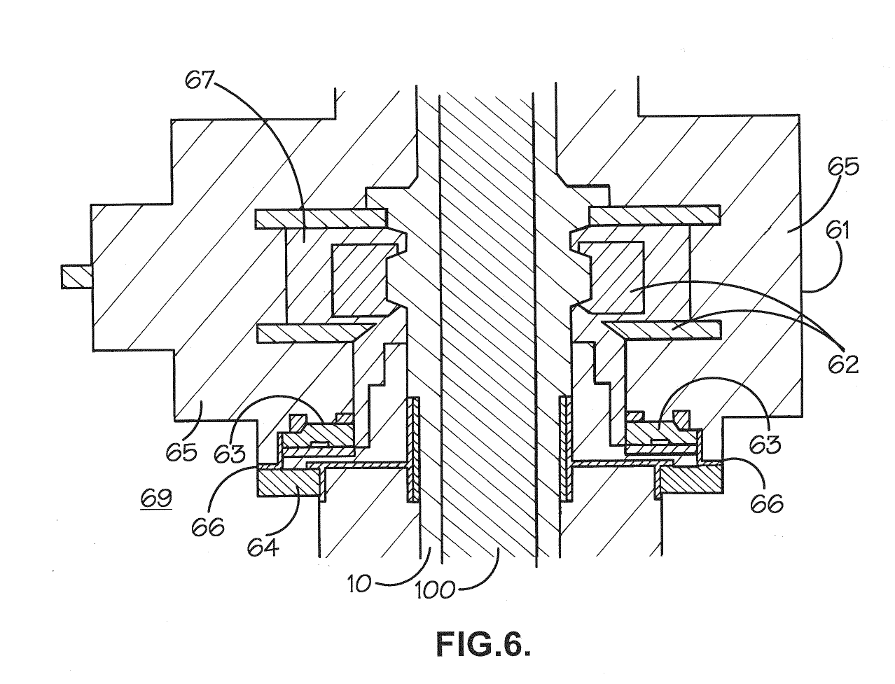

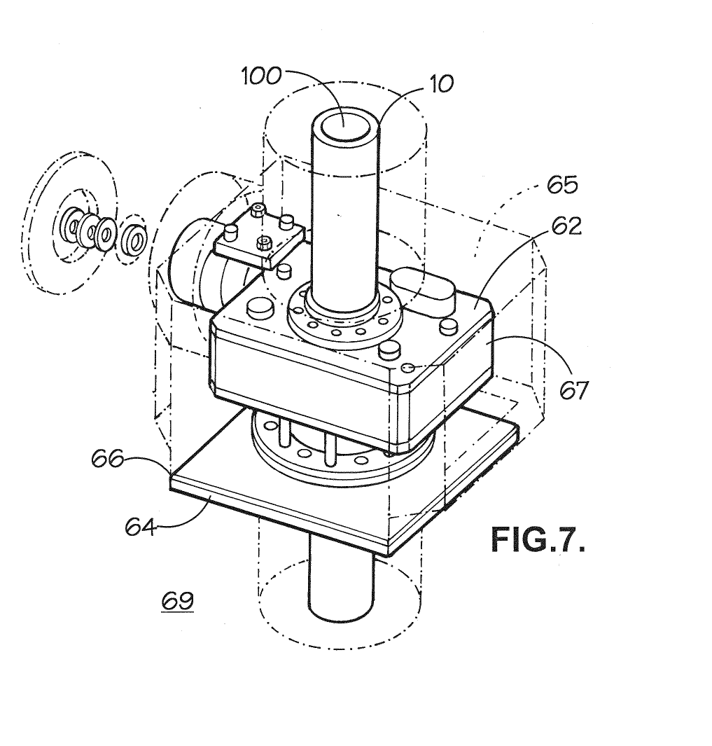

This is illustrated in FIGS. 6 and 7. A clamp 61, such as a Destec® clamp, is fastened to a process pipeline 10 carrying warm process fluid 100. The clamp 61 comprises steel clamp plates 62 mounted on an annular steel support 64, surrounded by insulation material 65. A small annular gap 66 is provided between the steel support 64 and the insulation material 65 so that water can leak in past a soft seal 63 to a water cavity 67 in the region between the steel plates 62 adjacent the process piping 10. This forms a vertical water trap in that the ambient cold water 69, surrounding the clamp 61, enters the water cavity 67 and is warmed by the process fluid 100 in the pipe 10. This makes it lighter than the colder ambient water 69 and it will thus effectively be trapped in the water cavity 67 thus conserving heat around the process pipe 10. Although there is no physical barrier between the warm water in the water cavity 67 and the cold ambient water 69, there is very little mixing of the water because the warmer water is trapped vertically above the colder water. Thus heat loss due to convection is reduced.

The soft seal 63 could be soft enough to prevent pressure build up between the water cavity and the sea (e.g. due to a change in process temperature) and may be made from a silicone based resin combined with glass microshapes such as that known as novolastic material. The insulation material may be made of novolastic material in which case the seal ring 63 can be shaped from the insulation material itself. This avoids using a separate material to be fixed in place.

The effect of this arrangement (which is sometimes known as dog house) can be enhanced by using a complex-shaped inner housing to reduce the volume of water in the thermal trap and to more effectively trap warm water, and further restrict internal water circulation, thus improving heat retention in the box.

Suitable complex shapes for the inner housing might take many forms, such as different sized and shaped blocks with a plurality of faces projecting into the inside of the thermal trap to reduce the water volume in the trap, and restrict water circulation in the trap.

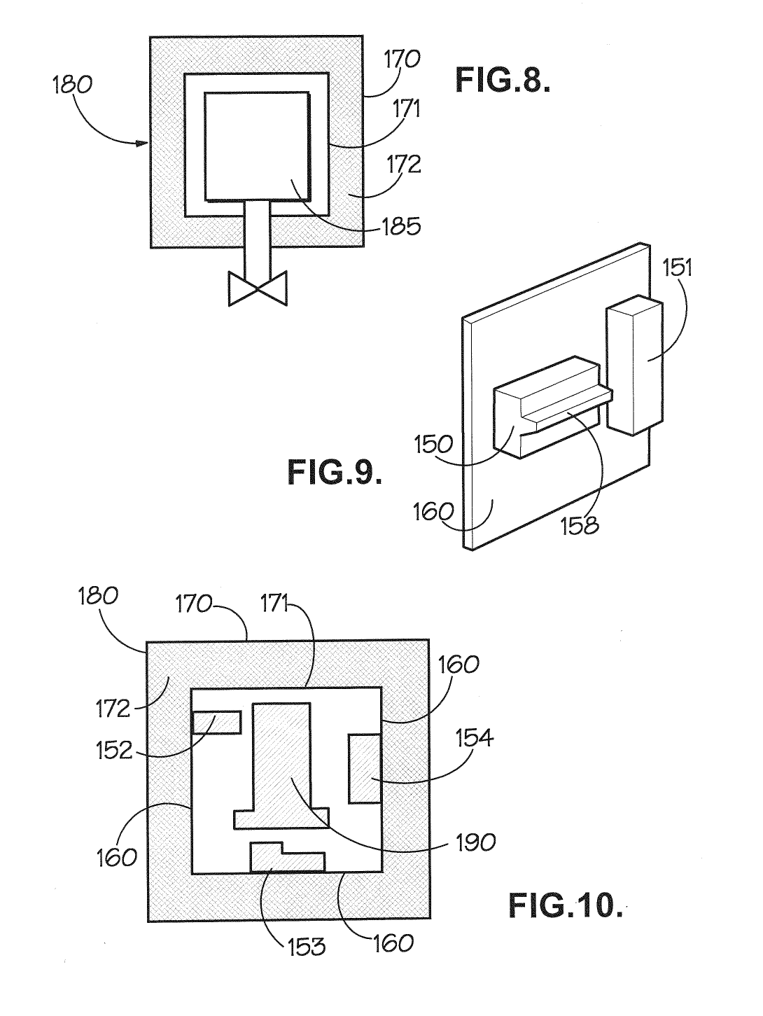

A dog house can be connected around items such as valves, actuators and pumps and filled with insulating material. Some examples are shown in FIGS. 8 to 12, which also shows examples of complex shapes 150, 151, 152, 153 and 154 projecting from the inner walls 160 of the dog house housing 180.

In FIG. 8 two simple, flat sided housing boxes 170, 171 are arranged one inside the other and insulation material 172 is put in the cavity between the two boxes 170, 171. The housing 180 surrounds an item 185 of equipment, which may be a valve, pump, actuator or other item.

The flat walls 160 for the inner housing or mould 171 can be connected together after the complex solid shapes 150-154 are fitted to the inside wall 160.

As shown in FIG. 9 two complex solid shapes 150, 151 are fitted to an inside wall 160. One shape 151 is a block with four rectangular sides and two square sides. The other shape 150 is also rectilinear but has an additional flat finger 158 projecting away from the surface of the inside wall 160. The two blocks 150, 151 are fixed to the wall 160 generally perpendicular to each other.

FIG. 10 shows such walls 160 connected together to form an inner box 171 around an actuator 190. Complex shaped blocks 152, 153, 154 are attached to the walls 160 projecting towards the actuator 190 to occupy space in the dog house housing 180. Insulation 172 surrounds the inner box 171 and is encased in an outer box 170 to form the housing 180.

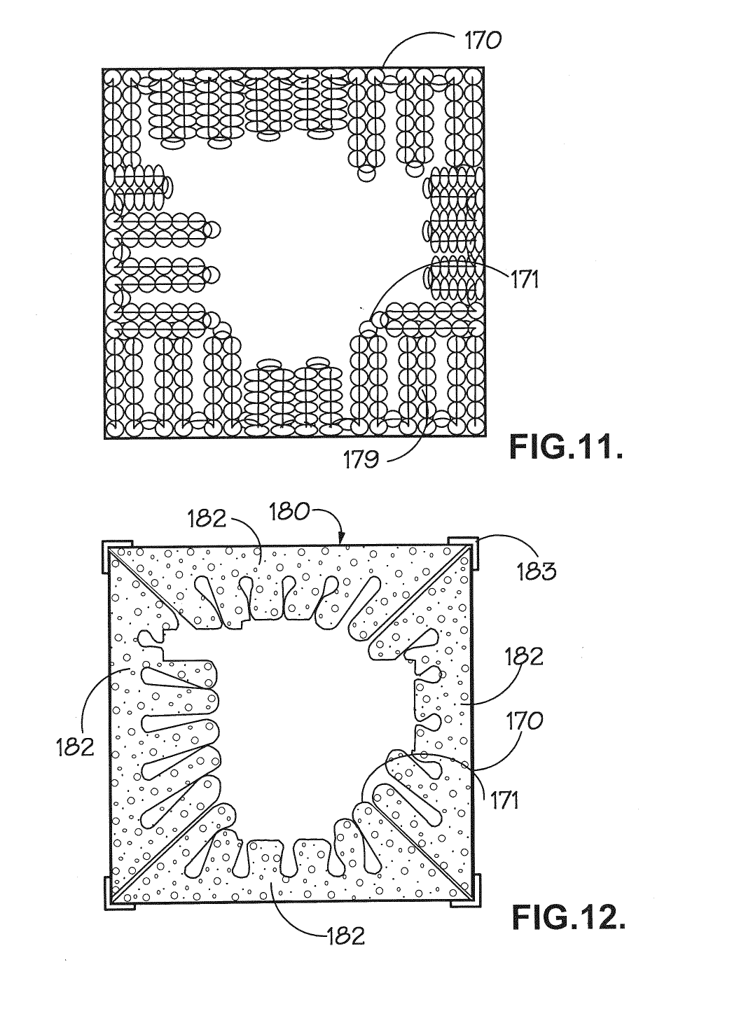

In FIG. 11 the complex shape of the inner box 171 is formed by “bubble wrap” 179 which is folded and wrapped into a convoluted shape to surround an item.

In FIG. 12 the housing 180 is formed of tapering sections 182 which are fitted together and fastened at their corners 183 around an item to be insulated. The resulting inside surface 171 may be formed to closely mirror the shape of the item to be encased in the dog house housing 180.

The complex shapes are adapted to improve insulation, reduce the water cavity and restrict water movement. The complex shapes 150-154 can be adapted to suit the application, depending on the part of the system (e.g. valve, actuator, pump etc.) which the dog house is intended to fit around. They can be individually machined to fit closely around a specific part to reduce the space within the dog house housing 180 which water can occupy.

Advantageously the complex shapes can be made out of an engineering plastic known as POM (Polyoxymethylene) which has a relatively low thermal conductivity and can be relatively easily shaped as required.

Bubble wrap can be used for insulation between the inner and outer boxes of a dog house and/or to form the inner surface 171. This is inexpensive and generally easy to shape.

The design allows the dog house to be constructed so that it can be opened and closed relatively easily to allow for maintenance of the clamp or other part being insulated in this way.

In another embodiment a pump or compressor can be arranged so that heat generated while it is running is conducted to a bypass line to keep the bypass line warm. For example the bypass line can be integrated into the pump body so that they are effectively thermally one unit.

The bypass line may be located within the pump housing or it can be clamped to it.

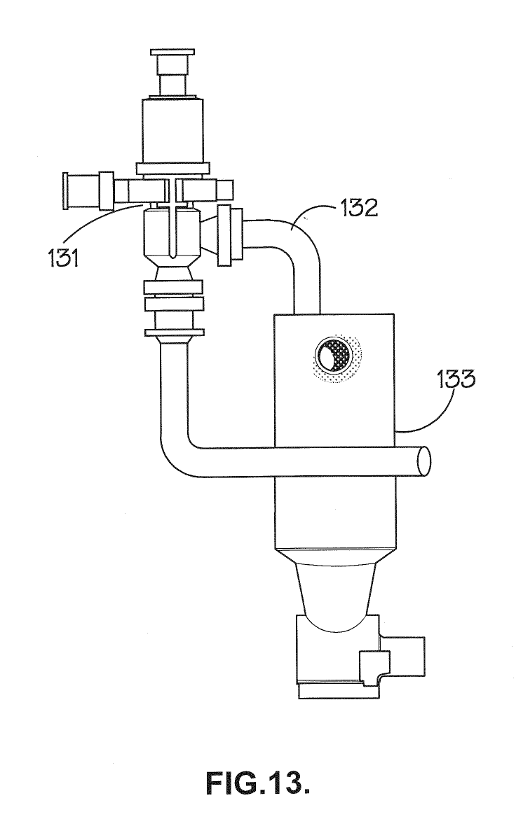

Similarly heat generated by a flow splitter can be used to keep other lines warm. A flow splitter is shown in FIG. 13. This is used on multiphase fluid pump applications to allow a liquid rich fluid flow to be extracted through the recirculation line and allows for the fluid flow downstream of the pump to be split into two equal flow lines. It comprises a choke 131 designed to resist the flow of solid particles to prevent them being recirculated. A majority of the length of piping 132 may be routed inside the splitter tank 133 to keep it relatively warm and above minimum steady state temperature.

1. An apparatus for thermal management of a hydrocarbon fluid transport system, the apparatus comprising:
means for maintaining the temperature of hydrocarbon fluid in the transport system at a temperature above the temperature at which hydrocarbon hydrates will form.

2. The apparatus according to claim 1, further comprising:
an inhibitor arranged to inhibit thermal conduction between the hydrocarbon fluid and ambient surroundings of the transport system.

3. The apparatus according to claim 2, wherein the inhibitor comprises insulation material.

4. The apparatus according to claim 3, wherein the transport system comprises a valve and a valve actuator and the inhibitor comprises insulation material located between the valve and the valve actuator to inhibit thermal conduction between the valve and the valve actuator.

5. The apparatus according to claim 4, comprising a stem connecting the valve to the valve actuator, wherein the inhibitor is arranged to inhibit the flow of heat along the stem between the valve and the valve actuator.

6. The apparatus according to claim 5, wherein the stem has a hollow part.

7. The apparatus according to claim 6, wherein the insulation material is located in the hollow part of the stem.

8. The apparatus according to claim 2, wherein the transport system comprises a valve and a valve actuator, and the inhibitor comprises a support plate connecting the valve to the actuator, wherein the support plate is adapted to inhibit flow of heat between the valve and the valve actuator.

9. The apparatus according to claim 8, wherein the inhibitor comprises a plurality of support plates arranged adjacent to each other.

10. The apparatus according to claim 4, wherein the inhibitor comprises thermal insulation material arranged to separate the valve actuator from ambient surroundings of the valve actuator.

11. The apparatus according to claim 3 wherein the insulation material comprises any one or any combination of foam, bubble wrap, carbon steel, or stainless steel.

12. The apparatus according to claim 10, wherein the inhibitor comprises a housing surrounding the valve actuator.

13. The apparatus according to claim 12, wherein the housing has a complex internal shape.

14. The apparatus according to claim 12, wherein the housing comprises an inner housing and an outer housing and an insulating barrier between the inner housing and the outer housing.

15. The apparatus according to claim 1, comprising a plurality of valves, each valve configured to change a rate of flow of the hydrocarbon fluid through the respective valve, wherein at least two valves are thermally connected together.

16. The apparatus according to claim 15, wherein the at least two valves are thermally connected together over an area such that the combined surface area of the thermally connected valves is less than the sum of the surface areas of the at least two individual valves.

17. The apparatus according to claim 15, comprising an inhibitor configured to inhibit flow of heat between the thermally connected valves and another valve.

18. The apparatus according to claim 1, wherein the transport system comprises a compressor and a bypass line of a valve system, and the apparatus further comprises means for thermally coupling together the compressor and the bypass line.

19. The apparatus according to claim 1 wherein the hydrocarbon fluid transport system comprises:
at least one pipe in which the hydrocarbon fluid flows;
a dead leg in which the hydrocarbon fluid is stationary or slow moving; and
means for transferring heat from the hydrocarbon fluid to the dead leg.

20. The apparatus according to claim 19 wherein the at least one pipe is arranged to be thermally connected to the dead leg.

21. The apparatus according to claim 20 wherein the at least one pipe is arranged to pass through a splitter tank.

22. The apparatus according to claim 1 further comprising means for increasing the thermal capacity of the system to reduce thermal transfer from the fluid to its ambient surroundings.

23. A method for thermal management of a hydrocarbon fluid transport system, the method comprising maintaining the temperature of hydrocarbon fluid in the transport system at a temperature above the temperature at which hydrates will form.

24. A method for thermal management of a fluid transport system, the system comprising:
at least one pipe for transporting the fluid; and
at least one unit for processing the fluid;
wherein the method comprises increasing the thermal capacity of the system to reduce heat transfer from the fluid to the ambient atmosphere surrounding the fluid transport system.
